(19) United States
(12) Patent Application Publication
(10) Pub. No.: US 2016/0300146 A1
(43) Pub. Date: Oct. 13, 2016

(54) Method of Design for Identifying Fixed and Removable Medical Prosthetics Using a Dynamic Anatomic Database

(71) Applicant: Behzad Nejat, Cupertino, CA (US)

(72) Inventor: Behzad Nejat, Cupertino, CA (US)

(21) Appl. No.: 14/684,421

(22) Filed: Apr. 12, 2015

(51) Int. Cl. G06N 5/04

(52) U.S. Cl. CPC G06N 5/046

(57) ABSTRACT

This disclosure pertains to hard and soft-tissue matching techniques, and in particular, a manner of retrieving recommendations to aid in bone replacement, reconstruction, and modification. A system consistent with the present disclosure includes a computer database having a plurality of bone data sets, a three-dimensional rendering device which generates the three-dimensional image of the contralateral structure of each bone, and a computing device coupled to the computer database to retrieve at least one of the plurality of bone data sets based on a set of criteria.

### FIELD

This disclosure pertains to hard and soft-tissue matching techniques, and in particular, a manner of retrieving recommendations to aid in bone replacement, reconstruction, and modification.

### SUMMARY

Hard and soft tissue matching and modification techniques consistent with the present disclosure include inputting a set of criteria into an anatomic recommendation computing (ARC) system. The set of criteria may include any of an age identifier, bone identifier, race identifier, gender identifier, height identifier, physical activity level identifier, and image(s) of a tissue structure. The ARC system may be used to execute a set of rules to meet the set of criteria. Based on executing the set of rules, identifying potential tissue match or modification recommendations from a computer database.

In some embodiments, the ARC system may include an input device, computer database, and a three-dimensional rendering device. The input device may include a computing system operable to submit a set of criteria for hard and soft tissue match or modification recommendations. The computer database may store numerous hard and soft-tissue data sets. A three-dimensional rendering device may be employed to generate three-dimensional images of hard and soft tissue structures which may be included within the data sets as image data.

### BRIEF DESCRIPTION OF THE DRAWINGS

To facilitate understanding, identical reference numerals have been used, where possible, to designate identical elements that are common to the drawings. The drawings are not to scale and the relative dimensions of various elements in the drawings are depicted schematically and not necessarily to scale. The techniques of the present disclosure may readily be understood by considering the following detailed description in conjunction with the accompanying drawings, in which:

FIG. 1 is a diagram of a human skeletal anatomy.

FIG. 2 is a diagram of hardware components of an anatomic recommendation computing (ARC) system consistent with the present disclosure.

FIG. 3 is a cone-beam computed tomography image of a human skull.

FIG. 4 is a flow diagram of a method for generating hard or soft-tissue matches using a system as described herein.

FIG. 5 is a flow diagram of a method for generating hard-tissue modification recommendations using a system as described herein.

FIG. 6 is a flow diagram of a method for generating hard tissue recommendations based on functionality using a system as described herein.

### DETAILED DESCRIPTION

A detailed description of some embodiments is provided below along with accompanying figures. The detailed description is provided in connection with such embodiments, but is not limited to any particular example. The scope is limited only by the claims and numerous alternatives, modifications, and equivalents are encompassed. Numerous specific details are set forth in the following description in order to provide a thorough understanding. These details are provided for the purpose of example and the described techniques may be practiced according to the claims without some or all of these specific details. For the purpose of clarity, technical material that is known in the technical fields related to some embodiments have not been described in detail to avoid unnecessarily obscuring the description.

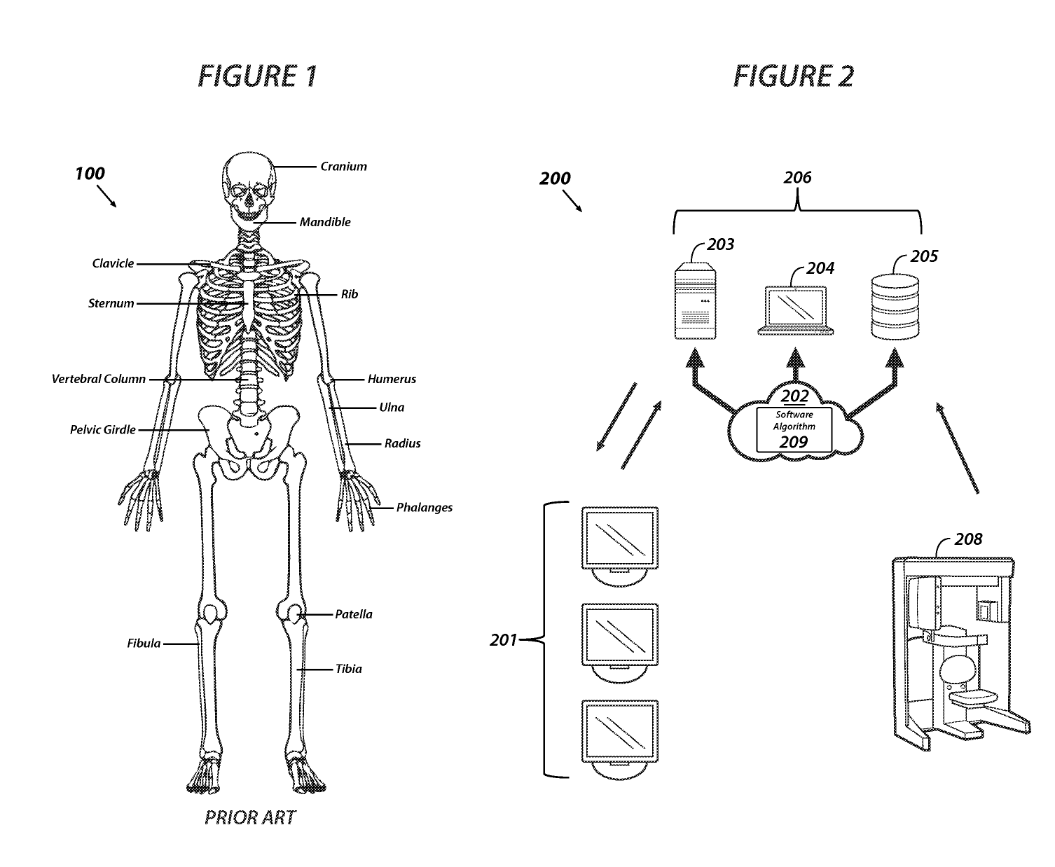

FIG. 1 is a diagram of a human skeletal anatomy 100. The present disclosure is agnostic to specific structures of the human body (e.g., sternum, clavicle, patella, malleus, cervical vertebrae, etcetera) and may be applicable to modifying or finding matches for various human bones. Although the present disclosure is directed to modifying or finding matches for hard and soft tissue for the human body, the present invention is not limited thereto. As such, techniques described herein may be adaptable to modify or find hard and soft tissue matches for animals.

Conventional methods used to replace missing hard and soft tissue structure(s) on human bone have been reduced to a missing data (regression) problem. Currently, medical practitioners decide the manner to replace or repair tissue despite the functional and aesthetic risks associated therewith.

The present invention addresses the aforementioned problem by utilizing, in some embodiments, artificial intelligence to replace missing structural data. For example, a system may be implemented to data mine a computer database to modify or find suitable hard or soft tissue matches for missing or damaged anatomic structures. In some implementations, the computer database may be dynamically filtered to create missing data in an optimized manner for each customized query to optimize for patient-or-doctor input criteria (e.g., age, race, weight, attractiveness, etc.).

In this disclosure, hard and soft tissue structures may be further classified as (i) fixed, permanent hard-tissue structures (e.g., femur), (ii) fixed, permanent soft-tissue structures (e.g., meniscus, labrum, fibrocartilage disc, etcetera) and (iii) removable, soft-tissue structures (e.g., prosthetic dentures). Fixed, permanent soft-tissue structures, such as intra joint auxiliary structures, may be considered “fixed” in that they are internal to joint-capsules and cannot be removed once surgically placed (e.g., attached to a permanent hard tissue). Advantageously, the ARC system described herein may be used to aid in reassembly or replacement for various types of tissue structures.

FIG. 2 is a diagram of hardware components of an ARC system 200 consistent with the present disclosure. In the embodiment shown, ARC system 200 includes one or more input devices 201 which is/are coupled to a computer database 206 having numerous hard and soft tissue data sets stored therein. ARC system 200 may be used to generate modification and replacement recommendations for permanent or removable tissue structures.

In particular, computer database 206 may be mined to find cancer-induced structure replacements and local-tissue resection replacements. In addition, computer database 206 may aid in cosmetic bone reconstruction and to recommend the location of for recommending locations for various surgical-bone position guides.

The output of ARC system 200 may include recommendations of constructed elements for permanent fixation to specific members of the human skeleton (e.g., titanium, bone mineral, or other bio-compatible materials) and constructed elements for semi-permanent (e.g., removable) devices to serve as a prosthetic appliance (e.g., prosthetic limbs, nasomaxillary obturator, etcetera).

A computer database 206 as anticipated herein may include memory within a personal computer 203, laptop computer 204, or storage system 205 such that hard and soft tissue data sets are stored and readily accessible therefrom. In some embodiments, computer database 206 may be implemented within a cloud storage system 202 and may be accessed by users from various remote locations.

Hard and soft tissue data sets stored within computer database 206 may include any of the following attributes: an age identifier, race identifier, bone identifier, bone dimensions, gender identifier, height identifier, attractiveness identifier, and a physical-activity level identifier. In some embodiments, the bone dimensions include three-dimensional data at key locations of anatomic surfaces that may be rendered into a bone surface. It should be understood by one having ordinary skill in the art that numerous data sets for each hard and soft tissue type may be included within computer database 206 to provide the best recommendation output for replacement, modification, and reconstruction efforts.

In some implementations, soft tissue data within computer database 206 may be used to aid in facial reconstruction whereas hard tissue data within computer database 206 may be used for replacement and bone modification efforts. However, one having ordinary skill in the art should appreciate that the present disclosure is not limited to the aforementioned use cases and that the data sets within computer database 206 may be used for various applications.

Notably, computer database 206 should have numerous data sets for each hard and soft tissue structure segregated by various attributes. For example, computer database 206 may contain thousands of left foot data of athletic Hispanic men that are 20 years of age. Accordingly, the vast number of data represented in computer database 206 should reflect the variety of human diversity.

Computer database 206 may include data entries that are segregated according to gender as the male and female anatomies are distinguishable in several aspects. Likewise, a race identifier may help matching, reconstruction, and modification efforts due to variances in racial skeletal and soft-tissue morphology currently known in the art of anthropometry.

A physical-level activity identifier may be an attribute of the degree of physical activity that the individual from whom the tissue data was taken was engaged in on a regular basis. A physical-level activity identifier may be any one of a sedentary activity level, a professional activity level, or a moderately-active activity level. As such, the data within computing database 206 are characteristics of the individual from which the data was taken. In some implementations, a physical-level activity identifier is related to a body mass index (BMI). As such, any one of the physical-level activity identifiers may be associated with a BMI value or range of values.

The data stored in computer database 206 may include an original three-dimensional tomographic image of a patient's (A) hard tissue or soft tissue structure. The data stored in computer database 206 may include original hard-tissue rendering data (e.g., A_{B}—bone and teeth) and soft tissue rendering data (e.g., A_{S}—skin). Both AB and As may be characterized as pre-treatment records for patient (A). Likewise, the original hard and soft-tissue rendering data may be outputted as the optimized A_{B′}, A_{S′}, respectively, by any of various means known in the art.

It should be noted that the present invention does not preclude any manner of retrieving the hard and soft tissue data sets as the present invention is agnostic thereto. It is anticipated by the present disclosure that several thousand data sets will be included in computer database 206 as the effectiveness of the system in some instances may be linked to the number of data sets present therein. For example, over 10,000 data sets are stored within the computer database 206. However, the present disclosure is not limited thereto and may be effective with several hundred data sets to generate useful recommendations.

In some embodiments, user may utilize an input computing device 201 to run a customized query via a software application 209 to retrieve tissue reconstruction modification and replacement recommendations from the computer database 206. Upon receipt of the customized query, software application 209 may generate possible recommendations based on the inputted criteria according to an algorithm.

In some implementations, the algorithm employed by software application 209 may assign weights to each criterion. For example, greater weight may be assigned to a bone identifier (i.e., bone's name) than to other criterion.

Software application 209 may further employ different algorithms for the type of tissue data requested. Advantageously, custom algorithms may be employed for each type of tissue structure according to design. Therefore, an algorithm employed by software application 209 may be unique for each tissue type. For instance, an algorithm employed to find tissue matches for a cervical vertebrae may be different than an algorithm employed to find tissue matches for a patella.

It should be understood by one having ordinary skill in the art that software application 209 may be resident in memory within a computing device which stores the data sets. In other embodiments, software application 209 may be resident within a separate computing device which has access to computer database 206. Advantageously, the retrieved tissue data may be parsed and presented to the user in any of various formats.

System 200 may also include a three-dimensional rendering device 208. For example, three-dimensional rendering device 208 may be used to produce three-dimensional images of tissue structures that are ipsilateral or contralateral to the structure being reconstructed. In some embodiments, three-dimensional rendering device 208 is a cone-beam computed tomography (CBCT) tool 208. A CBCT tool 208 may be employed to generate three-dimensional images when a human subject is in an upright, seated position. As such, CBCT is not limited by gravitational deformation attributed to images produced by other known techniques.

In addition, contrast enhanced imaging may be employed for cartilaginous structures that may be best imaged with greater contrast. In some implementations, contrast enhanced imaging includes injecting a contrast medium before CBCT is employed.

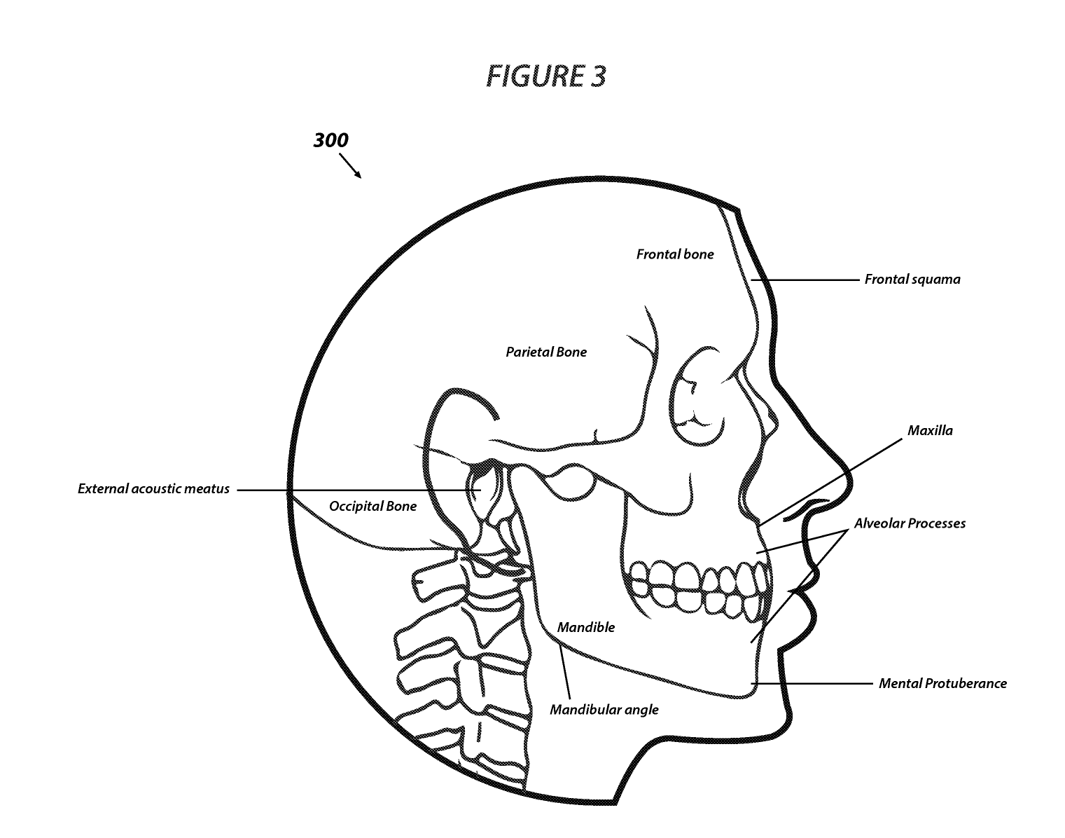

FIG. 3 is a CBCT image 300 of a human skull. As shown, image 300 is feature rich and may serve as tissue data within the computer database. The present disclosure is not limited to CBCT as CBCT may be primarily employed to generate images of facial bones. As such, other three-dimensional rendering devices may be incorporated within the ARC system disclosed herein to obtain images of various hard and soft tissue structures.

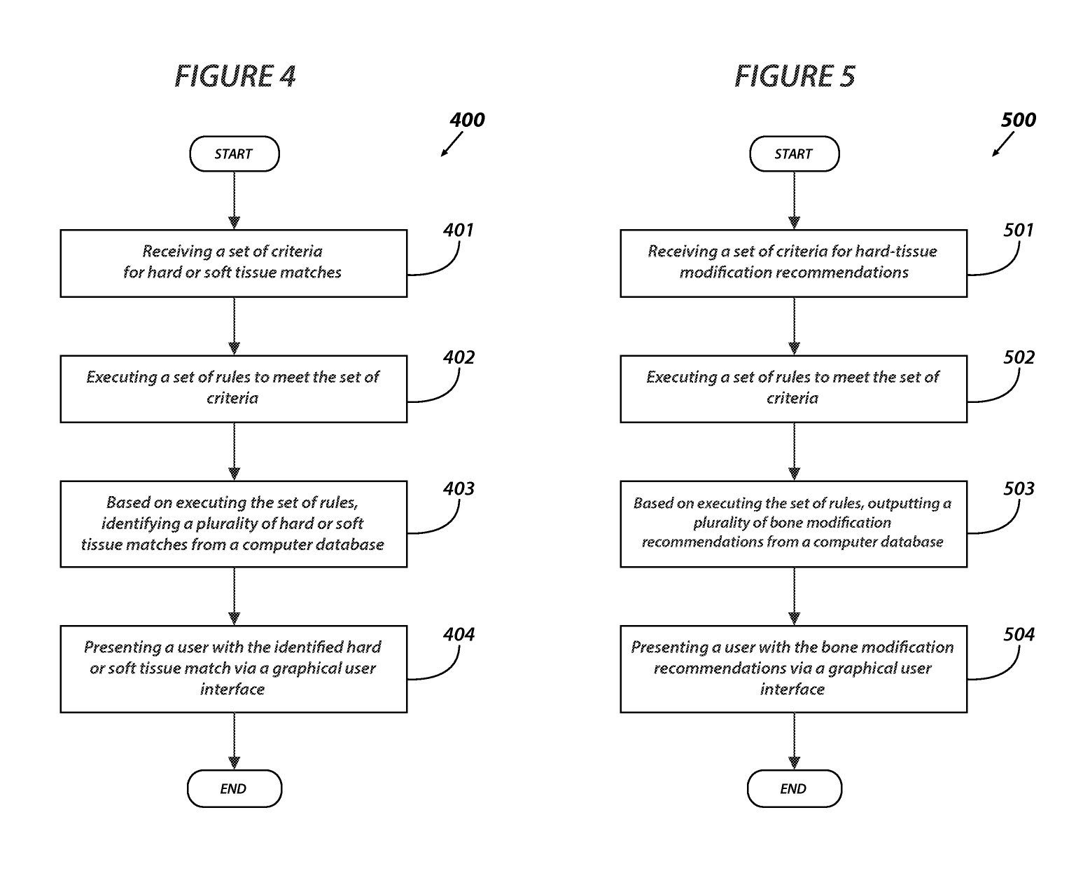

FIG. 4 is a flow diagram 400 of a method for generating hard or soft-tissue matches. In particular, the method disclosed in flow diagram 400 may aid in hard or soft-tissue replacement. The method begins with receiving a set of criteria for hard or soft tissue matches (block 401). In some embodiments, the set of criteria may include hard-tissue or soft-tissue rendering data.

Next, executing a set of rules to meet the set of criteria (block 402). The set of rules may be embodied in an algorithm of a software application. In some implementations, the software application mines the data sets within computer database using a general landmark-based geometric and/or local topography-matching algorithm to locate the most structurally appropriate replacement structure(s) therein.

To increase the effectiveness of the customized database queries, query-constructed sub-databases may be used to match the query identifiers. As a result, various match results may be presented to the user. Alternatively, match results may be combined into one structure with biased weighing as appropriate.

Advantageously, the present invention may be used to create transposed structures, implants, and prosthetics. For instance, a software application disclosed herein may implement a transpose function T(A_{B}) via a software algorithm to create contralateral hard-tissue structures. Likewise, a transpose function T(A_{S}) may be employed to create selected contralateral soft-tissue structures.

The software application may implement a difference function between the optimized and original hard-tissue rendering data (i.e., A_{B′}−A_{B}) to create a hard tissue “implant.” Likewise, the software application may implement a difference function between the optimized and original soft-tissue rendering (i.e., A_{S′}−A_{S}) to create a soft tissue prosthetic. Moreover, the software application may implement an overlay function (A_{S′}+A_{B′}) to create a soft tissue “prosthetic” that has underlying bony elements.

Based on executing the set of rules, identifying a plurality of hard tissue or soft tissue matches from a computer database (block 403). In some embodiments, the identified hard tissue or soft tissue matches are in the form of hard tissue or soft tissue meshes. For example, a hard tissue or soft tissue mesh may be employed as a three- dimensional object with an interior surface, exterior surface, and thickness. In some embodiments, a hard tissue mesh may be a three-dimensional image of a bone whereas a soft tissue mesh may include the thickness of the tissue (including the inside and outside surface).

Next, presenting a user with the identified hard or soft tissue matches (block 404). The identified hard tissue or soft tissue matches may be presented via a graphical user interface. A three-dimensional printer may be used to print the renderings of the hard or soft tissue matches. As such, blocks 403, 404 may be construed as the output from the ARC system based on the submitted customized query.

It should be understood that the present invention is not limited to the method exhibited in flow diagram 400 and may include other steps without obscuring the present invention. Moreover, methods consistent with the present disclosure may not include each step per se as described in flow diagram 400.

FIG. 5 is yet another flow diagram 500 of a method for generating hard-tissue modification recommendations using a system as described herein. The method begins with receiving a set of criteria for hard-tissue modification recommendations (block 501). In some implementations, the set of criteria is for a bone-modification recommendation.

Next, executing a set of rules to meet the set of criteria (block 502). The set of rules may be based on any of a set of algorithms depending upon the inputted set of criteria. For example, specific algorithms may be employed when providing recommendations for specific bones. Based on executing the set of rules, the ARC system outputs hard-tissue recommendations from a computing database (block 503).

In some embodiments, the recommendations may include information pertaining to which structures should be augmented. For example, the ARC system may recommend the location where a bone should be sliced and moved. In yet another example, the system may output recommendations which instruct that a titanium bracket or plastic stent should be employed at a specific location on a bone. Lastly, a user may be presented with the bone modification recommendations via a graphical user interface (block 504).

Furthermore, the ARC system may be used to aid in tissue reconstruction and reassembly efforts. For example, a three-dimensional rendering device, as described herein, may be used to take an image of the damaged tissue structure or area (along with their dimensions) and subsequently input into the ARC system. In addition, images of supporting structures (e.g., ligaments, supporting bones, etcetera) may be inputted along with their dimensions. Accordingly, the ARC system may be used to recommend hard or soft tissue modifications of individual or composite tissue structures to aid in tissue reassembly or reconstruction.

In addition, the ARC system may be used to fit displaced bone fragments together using a virtual-bone, fragment-reassembly algorithm within the system's software application. For example, as part of processing the initial patient CBCT record, the aforementioned fragment reassembly algorithm may output an image profile of a composite structure of the displaced bone fragments. Medical practitioners may use the image profile to aid in reassembly procedures.

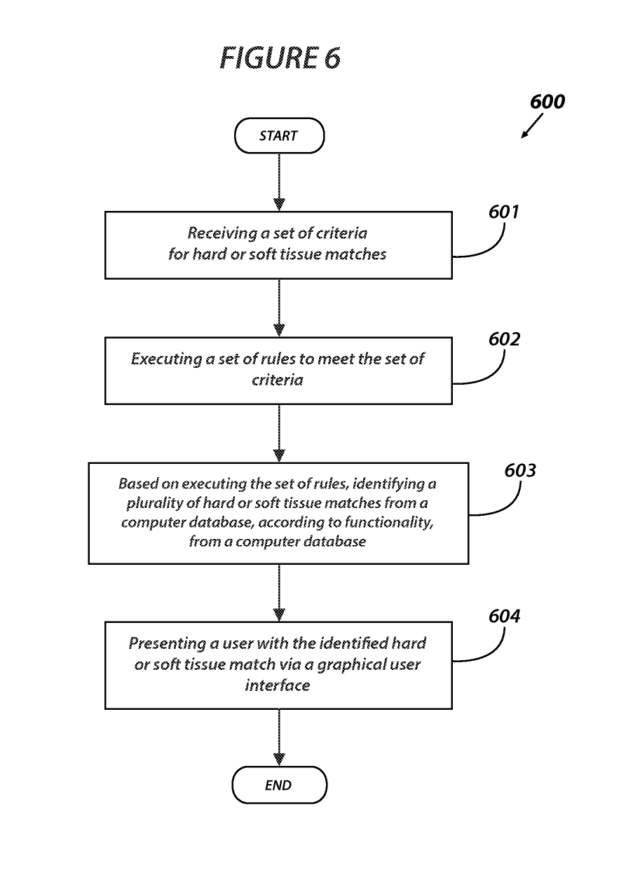

FIG. 6 is a flow diagram 600 of a method for generating hard tissue recommendations based on functionality using a system as described herein. In particular, the method disclosure in flow diagram 600 may aid in hard or soft-tissue replacement. The method begins with receiving a set of criteria for hard or soft tissue matches (block 601). In some implementations, the set of criteria is for hard or soft tissue matches with an emphasis on hard-tissue functionality. As such, the recommendations generated by the ARC system may give considerable weight to functionality.

In some embodiments, the ARC system may provide recommendations based on the level of physical activity of the recipient. For instance, instead of simply providing a transposed contralateral structure of a hard tissue structure, the ARC system may provide recommendations of enhanced hard-tissue structure(s) for greater durability or functionality (e.g., joint motion for baseball players).

For example, if the recipient is an athlete seeking a replacement for a worn-articulating surface of the tibia (e.g., or meniscus for a knee), the ARC system may recommend a more durable replacement than one that substantially matches the corresponding surface in the contralateral knee. The ARC system may also include functionality metrics (e.g., range of motion, flexibility, hardness, etcetera).

Next, executing a set of rules to meet the set of criteria (block 602). The set of rules may be embodied in an algorithm of a software application. The software application may mine the data sets within computer database using a general landmark-based geometric and/or local topography matching algorithm to locate the most structurally-appropriate replacement structure(s) therein.

Next, based on executing the set of rules, identifying a plurality of hard or soft tissue matches from a computer database, according to functionality, from a computer database (block 603). After the set of rules are executed, presenting a user with the identified hard or soft tissue match via a graphical user interface (block 604).

The ARC system described herein may generate recommendations of stent locations, surgical brackets, and other surgical guides to assist medical practitioners effectively modify bones at precise locations for ideal results, For example, the ARC system may recommend the precise locations for surgical guides on a tissue structure. As such, greater tissue modification, reconstruction, and replacement precision may be achieved.

Although the present disclosure has been described with regards to a computer database which stores tissue data sets, the present invention is not limited thereto. For example, the present invention may implement a public data repository to store human tissue data. As such, members of the public may submit via a data upload their own anatomic data to the public data repository. Accordingly, the public data repository may be accessible to the public for medical practitioners and others to initiate hard or soft tissue matches.

Moreover, future innovations will enable laypersons with the ability to upload their personal anatomic, physiological, and medical information to their own medical portal to enable easy access to medical professionals, all the while providing sufficient security measures. Individuals may also be able to retrieve medical information from medical professionals and store such information onto a portable recordable medium (e.g., external memory drive). At the individual's convenience, he or she can upload personal anatomic and physiological data to the public data repository for the benefit of the public for bone replacement, reconstruction, and modification applications.

Thus, an anatomic recommendation computing system consistent with the present disclosure may be employed to sift through anatomic data and provide precise tissue replacement, reconstruction, and modification recommendations. The implementations of the present disclosure are numerous by providing a framework from which tissue data may be acquired and distributed in a sophisticated manner.

The preceding Description and accompanying Drawings describe examples of embodiments in some detail to aid understanding. However, the scope of protection may also include equivalents, permutations, and combinations that are not explicitly described herein. Only the claims appended here (along with those of parent, child, or divisional patents, if any) define the limits of the protected intellectual-property rights.

What is claimed is:

1. A method, comprising:
receiving a set of criteria for hard tissue or soft tissue matches, said set of criteria comprises:
a hard tissue or soft tissue identifier;
a gender identifier;
a race identifier; and
an age identifier;
executing a set of rules to meet the set of criteria; and
based on the set of rules, identifying at least one hard tissue or soft tissue match from a database.

2. The method of claim 1, wherein the set of rules includes assigning a weight to each criterion to identify the at least one hard tissue or soft tissue match.

3. The method of claim 2, wherein the weight assigned to the hard tissue or soft tissue identifier is greater than the weight assigned to the other criterion.

4. The method of claim 1, wherein said set of criteria further comprises a physical-activity level identifier.

5. The method of claim 1, wherein the hard or soft tissue identifier is a medical name assigned to the hard or soft tissue identifier.

6. The method of claim 1, wherein the at least one human bone match includes greater than five hard or soft tissue identifiers.

7. The method of claim 1 further comprising presenting the identified at least one hard or soft tissue match via a graphical user interface.

8. A method, comprising:
receiving a set of criteria for hard or soft tissue matches;
executing a set of rules to meet the set of criteria;
based on executing the set of rules, identifying a plurality of hard or soft tissue matches from a computer database, according to functionality, from a computer database; and
presenting a user with the identified hard or soft tissue match via a graphical user interface.

9. The method of claim 8, wherein the plurality of hard or soft tissue matches from the computer database include three-dimensional images and dimensions of human bones.

10. The method of claim 8, wherein the set of rules includes assigning a weight to each criterion to identify at least one bone match and wherein the weight assigned to the three-dimensional image of the contralateral structure of the human bone is greater than the weight assigned to the other criterion.

11. The method of claim 8, wherein executing a set of rules to meet the search criteria includes optimizing the hard-tissue rendering data.

12. The method of claim 8, wherein the set of criteria comprises a bone identifier, gender identifier, race identifier, age identifier, and three-dimensional image of a contralateral structure of a tissue structure, and a height identifier.

13. A computer readable medium including code, when executed, to cause a machine to:
receive a set of criteria for soft tissue matches, said set of criteria comprises:
a bone identifier;
a gender identifier;
a race identifier;
an age identifier;
a height identifier;
a physical-activity level identifier; and
a three-dimensional image of a contralateral structure of the soft tissue obtained by a cone-beam computed tomography tool;
execute a set of rules to meet the set of criteria;
based on the set of rules, identify a plurality of soft tissue matches from a database; and
present a user with the identified at least one soft tissue match via a graphical user interface.

14. The computer readable medium of claim 13 further include code, when executed, to cause a machine to input the received set of criteria as variables of an algorithm.

15. The computer readable medium of claim 13 further include code, when executed, to cause a machine to assign a weight to each criterion to identify the at least one bone match wherein the weight assigned to the soft tissue identifier is greater than the weight assigned to the other criterion.

16. The computer readable medium of claim 13 further include code, when executed, to cause a machine to prompt a user for a set of criteria for soft tissue.

17. The computer readable medium of claim 13, wherein the soft tissue include includes eyes, skin, and cartilage.

18. A system, comprising:
a computer database having a plurality of bone data sets, wherein each bone data set includes:
a bone identifier;
a gender identifier;
a race identifier;
an age identifier;
a height identifier;
a physical activity level identifier; and
a three-dimensional image of a contralateral structure of each bone;
a three-dimensional rendering device which generates the three-dimensional image of the contralateral structure of each bone; and
a computing device coupled to the computer database to retrieve at least one of the plurality of bone data sets based on a set of criteria.

19. The system of claim 18, wherein the three-dimensional rendering device is a cone-beam computed tomography tool.

20. The system of claim 18, wherein the computing device is at least one of a desktop computer, laptop computing system, computer tablet, computer notebook, mobile phone, or smartphone.
